(19) United States
(12) Patent Application Publication
(10) Pub. No.: US 2008/0170477 A1
(43) Pub. Date: Jul. 17, 2008

(54) Remote controlled media systems and methods

(75) Inventor: Makoto Mitsumori, Hamamatsu-city (JP)

Correspondence Address: FOLEY & LARDNER, 2029 CENTURY PARK EAST, SUITE 3500, LOS ANGELES, CA, 90067, US

(73) Assignee: Roland Corporation

(21) Appl. No.: 11/654,377

(22) Filed: Jan. 17, 2007

(51) Int. Cl. G11B 21/08

(52) U.S. Cl. 369/30.04

(57) ABSTRACT

A media system for playing content on a media player with an electronic computing device for communication. When song title request information for a song title stored by a storage process is received from a computing device, song titles stored in the storage process are transmitted in a song title transmission process to the computing device, song selection information is received from the computing device, song performance information is read and the performance equipment runs a performance process from that performance information. When the performance equipment and the second communication process are run, the song titles are displayed on the display screen.

### BACKGROUND OF THE INVENTION

1. Field of the Invention

The present invention relates to media systems for playing content on a media player with an electronic computing device, components of such systems and methods of making and using such systems.

2. Related Art

Traditionally, media players, karaoke players, and other types of media systems store a large number of songs from which a user may select a song to play. In addition, with the advent of internet access, users can also access media of their choice, such as songs or ring tones, for use on their mobile phones and personal computers.

Japanese Published Unexamined Application Bulletin No. 1997 (Heisei 9)-218688 describes a karaoke player that includes a table of contents of karaoke song titles. Each song title in the table of contents is printed with a barcode song number. When a song is to be selected, a barcode reader reads the barcode corresponding to the song. As a result the song is played. The song selection and settings, such as sound field control effect, are controlled by the karaoke equipment.

When an infra-red remote control is used to control the increment/decrement buttons of the electronic musical equipment, song titles of selected songs from the electronic musical equipment are displayed.

In prior systems, when a user wished to select a song, the user would first have to find the relevant page of the table of contents containing the song. From that page, the user would then find and select the song. In order to select the song, a barcode reader would then read a barcode associated with the song. This process was not efficient, and if the barcode was missing or damaged, the user would be unable to select the song.

Using a traditional infra-red remote control device is not too desirable because song titles cannot be displayed on the remote control. The song titles can only be displayed on costlier remote controls specifically designed for displaying the song titles.

### SUMMARY OF THE DISCLOSURE

A purpose of embodiments of the invention is to address the problems described above by creating an easy-to-use remote controlled media system for selecting and playing music.

In order to achieve that purpose, a performance system according to an embodiment of the invention, and the information processing equipment of an embodiment of the invention may be configured to operate, as described below.

In a first communication process for communication between external hardware and a storage process, performance information of numerous songs may be processed. When song title request information for a song title stored by the storage process is received via the first communication process, song titles stored in the storage process are transmitted in a song title transmission process. When song selection information is received from the first communication process in the song selection information receipt process, song performance information is read in the storage process in response to the song selection information received from song selection information receipt process. The performance equipment runs a performance process from that performance information. When the performance equipment and the second communication process are run, the song titles are displayed on the display screen. When song title request information for song titles stored by the storage process is transmitted to the performance equipment via the second communication process, the song title is received from the performance equipment via the second communication process in the song title receipt process. The numerous song titles received from the song title receipt process are displayed on the display screen in the display process. From the display process a selection process is conducted from among the numerous song titles displayed. The selection information associated with the selected song title is transmitted via the second communication process in the song selection information transmission process.

In the performance system described above, communication between the storage process of the performance information of numerous songs and external hardware is processed via the first communication process. When song title request information is received for stored song titles via the first communication process, the song title transmission process transmits the stored song title. When song selection information is received via the first communication process in the song selection information receipt process, the song performance information is read by the storage process in accordance with the received song selection information in the song selection information receipt process. The performance equipment is equipped to process this performance information to run a performance. When communication with the performance equipment is conducted via the second communication process, the song title is displayed on the display screen. When the song title request information for stored song titles is transmitted via the second communication process to the performance equipment, the song title is received from the performance equipment in the song title receipt process via the second communication process.

The numerous song titles received in the song title receipt process are displayed on the aforementioned display screen in the display process. The selection process is then conducted by selecting from among the numerous song titles displayed in the display process. The selection information related to the selected song title is then transmitted via the aforementioned second communication process. Because the information processing equipment is prepared for the song selection information transmission process, even if the song title information stored in the performance equipment is not prepared for the information processing equipment when the song title is received, generally, the song selection process from the information processing equipment can be completed via remote control.

In the performance system according to a further embodiment, the song title request process transmits the song title request information of the assigned song title displayed on the display screen. The assigned song title is received in the song title receipt process. The assigned song title is displayed on the display screen. In the song title receipt process, because the assigned song title is received, the display screen is able to display the song titles.

In the performance system according to a further embodiment, the information processing equipment displays information based on song selection on the display screen. The information may be displayed graphically or in other ways. The assigned song titles from the song title assignment process are displayed on the display screen. The display process shows the assigned song titles from the song title assignment process. The information processing equipment is equipped to display information for the assigned song title on the display screen. The information may be displayed graphically or in other ways. The display process displays the assigned song title from the song title assignment process, so graphics for song selection are displayed in relation to window size. Because the number of song titles is set, the user is able to read the displayed song titles easily.

In the performance system according to a further embodiment, the song title request process transmits the song title request information for the assigned song title from the song title assignment process via the second communication process. In the song title receipt process, the assigned song title is received from the song title assignment process via the second communication process. In the song title receipt process, because assigned song titles from the song title assignment process are received via the communication process, only necessary information is transmitted; therefore, wireless communication is effectively conducted smoothly and quickly.

In the performance system according to a further embodiment, the performance equipment runs via wired communications in the wired communication process. The information processing equipment is equipped to run via wireless communication in the wireless communication process. The wired communication process receives information transmitted from the wireless communication process. The information received from the wireless communication process is transmitted from the wired communication process using the transmission switch equipment. The first communication process communicates with the transmission switch equipment via a wired connection and the second communication process communicates with the transmission switch equipment via wireless connection. The transmission switch equipment processes wired communication via the first communication process and wireless communication via the second communication process. Generally, the performance system can be configured to use wireless communication equipment for communication between the information processing equipment and performance equipment.

In the performance system according to a further embodiment, the first communication process communicates with the wired communication process via an RS-232C connection. The second communication process and the wireless communication process communicate using TCP/IP protocol via a wireless LAN connection. Because the second communication process and wireless communication process communicate using TCP/IP protocol via wireless LAN connection, in general, the performance system can easily be configured to use a variety of different communication process.

For the performance system according to an embodiment, the information processing equipment is a PDA. Because the information processing equipment is a PDA and is easily obtained, the PDA provides a readily available device that is able to utilize the wireless remote control.

For the performance system according to an embodiment, the information processing equipment is a personal computer. Because the information processing equipment is a personal computer and is easily obtained, the personal computer provides a readily available device that is able to utilize the wireless remote control.

The remote control program according to an embodiment of the invention is equipped with information processing equipment that runs the communication process that allows the performance equipment to display the song titles on the display screen. When song title request information for a song title stored by the performance equipment is transmitted to the performance equipment via the communication process, song titles are received from the performance equipment via the communication process in the song title receipt step. The numerous song titles received in the song title receipt step are displayed on the display screen in the display step. The selection step is conducted when a song is selected from among the numerous song titles displayed in the display step. From that selection step, selection information is transmitted in response to the selected song title via the communication process in the song selection information transmission step. Even if the song title information stored for performance equipment is not prepared for the information processing equipment when the song title is received, generally, a remote control can be used for the song selection process from the information processing equipment.

In the remote control program according to a further embodiment, the song title request step transmits song title request information and displays the assigned song title on the display screen. In the song title receipt step, the assigned song titles are received. Because the assigned song titles are received in the song title receipt step, the display screen is able to display the selected song titles.

In the remote control program according to a further embodiment, the display screen displays the information for the song selection. The information may be displayed in graphic display or other ways. The assigned song title from the song title assignment step is displayed in the display screen. The display step displays the assigned song title from the song title assignment step. Thus, the remote control program is equipped to display the information for song selection and show the assigned song titles from song title assignment step on the display screen and the display screen. Because the display step displays the assigned song titles from the song title assignment step and the graphics for song selection (i.e. the size of the window is displayed in accordance to how many song titles are set), the user is able to read the displayed song titles easily.

In the remote control program according to a further embodiment, the song title receipt step transmits song title receipt information for the assigned song title from the song title assignment step via the communication process. In the song title receipt step, the assigned song titles from the song title assignment step are received via the communication process. Because the assigned song titles from the song title assignment step are received via the communication process, only the necessary information is transmitted and wireless communication is effectively conducted smoothly and quickly.

In the remote control program according to a further embodiment, the information processing equipment runs the programs based on the operating system in use. The song title assignment step displays the assigned song titles on the display screen of the operating system in reference to the information stored regarding the size of the display area or the display screen. Thus, in the song title assignment step assigned song titles are displayed on the display screen in accordance with the stored information on the size of the display screen for that operating system. Therefore, the program is easily configured to be compatible with the operating system in use.

In the remote control program according to a further embodiment, the performance equipment stores the performance information of numerous songs in each of the genres in the storage process. The song title request step transmits the song title request information, which includes the selected genre and the song titles included in that genre. Because song titles are selected via genre, songs can be easily selected.

In the remote control program according to a further embodiment, the information processing equipment runs the browser information on the operating system. In the display step, song titles are displayed on the display screen via the browser. In the display step, because the song titles are displayed on the display screen via the browser, generally, once installed onto an operating system of a PDA or personal computer, the browser should be able to easily configure the program. In the control program according to an embodiment of the invention, the storage process of the performance information of numerous songs is equipped for communication with external hardware. A performance is run by the performance equipment in response to the song selection information received via that communication process. When song title request information is received for song titles stored in the storage process via the communication process, the song title transmission step transmits the song title stored in the storage process. When song selection information is received from the communication process in the song selection information receipt step, the performance information is read in the storage process in response to song selection information information received in song selection information receipt step. The performance information is processed for the performance step. Therefore, the stored song titles are transmitted to partner equipment via the communication process and song selection process can be completed using that equipment.

### BRIEF DESCRIPTION OF THE DRAWINGS

FIG. 1 is a block diagram of an example of a configuration of an electronic computer device in accordance with an embodiment of the present invention;

FIG. 2 is a block diagram of an example of a configuration of a media player in accordance with an embodiment of the present invention;

FIG. 3(a) is an example of a song selection menu displayed on a screen of an electronic computing device when selecting a song with a remote control program in accordance with an embodiment of the present invention;

FIG. 3(b) is an example of a control menu displayed on a screen of an electronic computing device in accordance with an embodiment of the present invention;

FIG. 4 illustrates an example of a user interface using a larger display screen in accordance with an embodiment of the present invention;

FIG. 5 (FIGS. 5A and 5B) is a flowchart of an example of processes performed by a remote control program for playing and selecting a song on a media player; and

FIG. 6 is a flowchart of an example of processes performed by a media player in response to a remote control program.

### DETAILED DESCRIPTION OF PREFERRED EMBODIMENTS

Reference will now be made to the accompanying drawings, which assist in illustrating various pertinent features of embodiments of the present invention. The drawings refer to an electronic computing device, in particular a Personal Digital Assistant (PDA), but embodiments of the present embodiments also include, but are not limited to, mobile phones, personal computers, and the like.

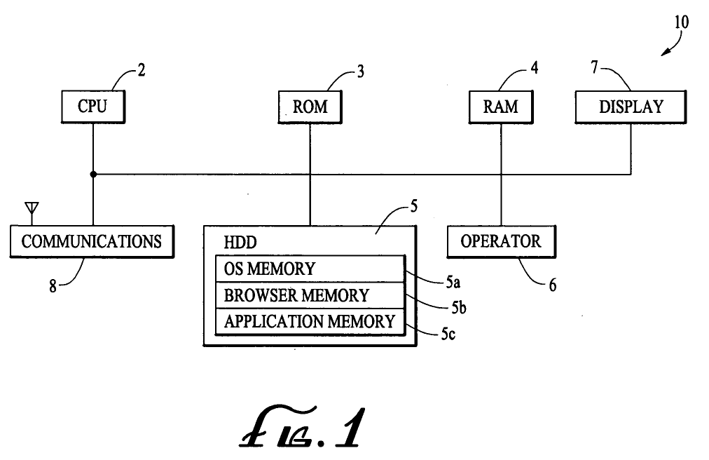

FIG. 1 is a block diagram of an example of an electronic computing device configuration in accordance with an embodiment of the present invention. As shown in FIG. 1, the electronic computing device is a PDA 10. The PDA 10 comprises a CPU (Central Processing Unit) 2, a ROM (Read Only Memory) 3, a RAM (Random Access Memory) 4, a Hard Drive Disk (HDD) 5, an operator 6, a user interface 7, and a transmitter 8.

The CPU 2 is configured to process programs through use of the ROM 3 and the RAM 4. The ROM 3 is configured to control the data and the programs stored in the RAM 4. When the CPU 2 runs the program, it uses the RAM 4 to process the program stored on the HDD 5. The HDD 5 comprises an operating system memory 5a for running an operating system (OS), a browser memory 5b for storing a browser, and an application memory 5c for storing an application program.

The application memory 5c may be configured to store a remote control program that can, for example, select a particular song or adjust performance parameters of a media player 20 (discussed later). The remote control program may be, for example, created with Macromedia Flash software. Flash software can create web content using both voice filed and vector graphics animation. A benefit of using Flash-based software is that the software is compatible with various different OSs or browsers.

The operator 6 controls a position of the user interface 7 by use of, for example, a mouse pointer, a touch screen, or the like. The operator 6 may also be used to input an alphanumeric code.

The user interface 7 may be configured to select a song to be played by the media player 20 from among a plurality of song titles displayed on the display screen. In addition, the user interface 7 can be configured to adjust a volume and a tempo for the media player 20. In various embodiments of the present invention, the user interface 7 can be configured for use with an LCD screen, which can be configured to function as a touch panel. Accordingly, the position of the user interface 7 can also be manipulated by touch.

The transmitter 8 includes an antenna for wireless communication. The antenna of the transmitter is configured to communicate wirelessly with a computer networking device 50, such as a router, or the like (discussed later) via a wireless LAN connection by using a Transmission Control Protocol/Internet Protocol (TCP/IP), which is currently the standard protocol for Internet and Internet use.

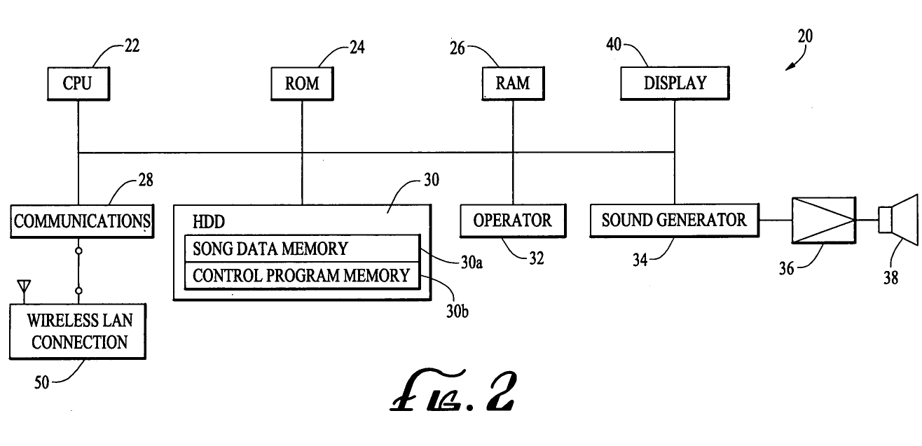

FIG. 2 is a block diagram of the media player 20 illustrating a configuration in accordance with an embodiment of the present invention. The media player 20 includes a CPU 22, a ROM 24m a RAM 26, a transmitter 28, a hard disk drive (HDD) 30, an operator 32, and a user interface 40. The CPU 22 is configured for completing each process in the ROM 24 as dictated by a stored control program. The ROM 24 stores each type of control program and the data associated with the control program. When the CPU 22 runs a program stored on the HDD 30, the CPU 22 transfer the program to the RAM 24 and runs the program accordingly.

The transmitter 28 is connected to the computer networking device 50, such as a router, with a serial connection, such as a RS-232C standard base serial cable, or the like. The computer networking device 50 is configured to transmit a serial signal to the transmitter 28. The computer networking device 50 may also include a wireless antenna for transmitting a signal wirelessly via a wireless LAN connection, such as IEEE802.11b, or the like.

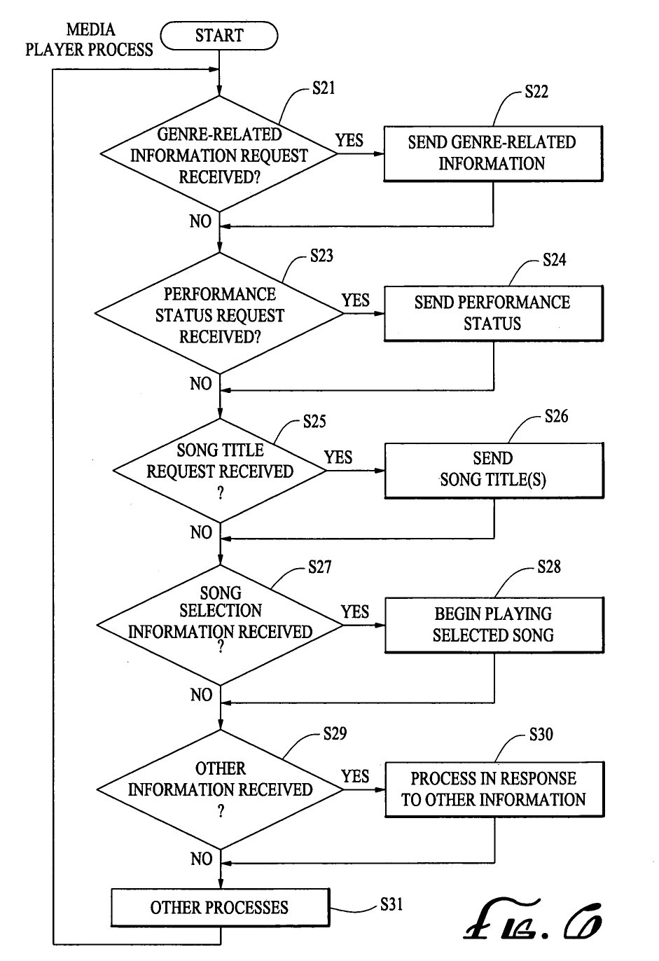

The HDD 30 comprises a song data memory 30a and a control program memory 30b. The song data memory 30a links a song selection number to a large volume of song data, such as media content, song titles, lyrics, and graphical content. The control program memory 30b stores a program for playing a selected song (Refer to FIG. 6).

The data stored by the song data memory 30a comprises a song database that includes song information, such as genre categorized under, for example, rock, classic, folk, pop, Latin, etc., song titles, song artists, song writers, lyricists, release dates, publishers, song selection numbers, etc. Users can search through this song database to select a song of their choice.

In addition, the data stored by the song data memory 30a is configured such that the sound generator 34 will play or stop a song once the song is processed by the media player 20.

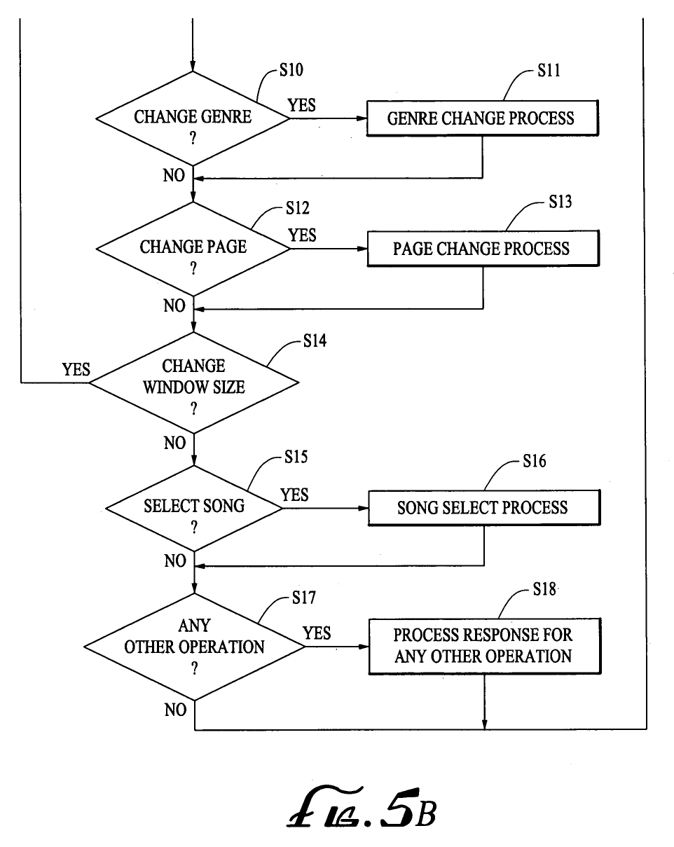

The program stored by the control program memory 30b, as described later with respect to FIG. 5, receives information from the PDA 10 and causes the media player 20 to process the information accordingly. For example, when song selection information is received from the PDA 10, the song data associated with the song selection information is read by the song data memory 30a, which then automatically plays the selected song via the sound generator 34.

The operator 32 is configured for controlling performance parameters of the media player 20, such as volume, echo levels, and the like. The sound generator 34 is configured for receiving the media content processed by the media player 20 and then generating a corresponding musical tone. The music tone generated by the sound generator 34 may be outputted with an amplifier 36 and speakers 38.

In various embodiments of the present invention, the user interface 40 may be configured to display song lyrics in addition to background music when, for example, the song being played is a karaoke song. In further embodiments of the present invention, the user interface 40 may also be configured to display a plurality of songs that can be selected on an attached LCD, for example.

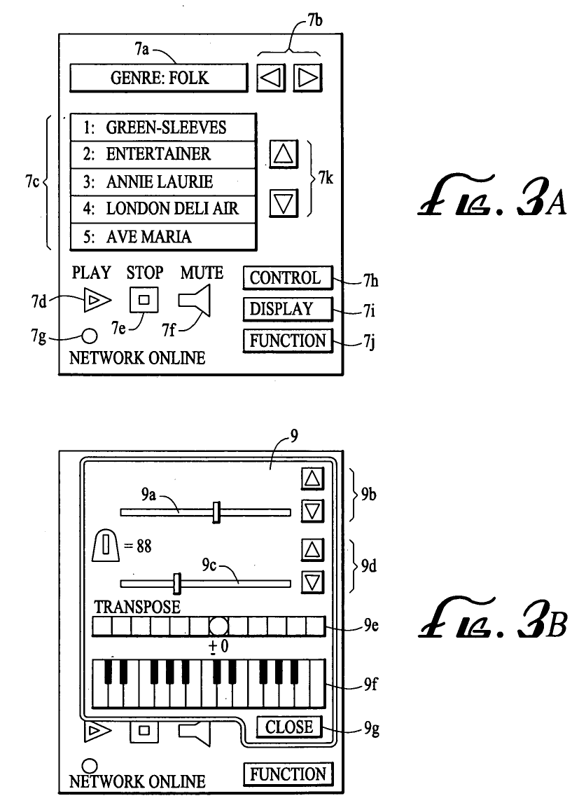

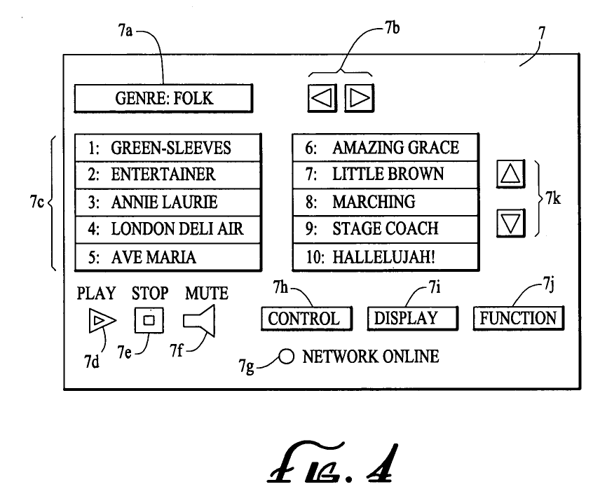

FIG. 3(a) is an example of a song selection menu displayed on a screen of an electronic computing device, such as the PDA 10, notebook computer, or the like, when selecting a song with the remote control program in accordance with an embodiment of the present invention. FIG. 3(b) is an example of a control menu displayed when an options button 7h is selected in accordance with an embodiment of the present invention.

As shown in FIG. 3(a), the song selection menu may include: a genre display area 7a for displaying a currently selected genre, a genre-changing button 7b for changing song genres, a song title display area 7c for displaying a plurality of song titles, a song title changing button 7k for changing the plurality of song titles, a play button 7d for playing a selected song, a stop button 7e for stopping a song currently playing, a mute button 7f for muting volume, an options button 7h for controlling various settings, a display button 7i for opening a window to display miscellaneous media content, a function button 7j for opening a window to display, for example, musical notes, and a network indicator 7g for showing a network signal strength.

If the electronic computing device, such as the PDA 10, is activated by the remote control program, the remote control program promptly requests the media player 20 for the genres stored by the song data memory 30a, as well as the songs associated with the genres. Then information pertaining to resolution and size of the screen set by the OS is obtained and each type of display area (7a, 7c) and each type of button (7b, 7d, 7e, 7f, 7h, 7i, 7j, 7k) is configured accordingly on the user interface 7. At this time, the number of song titles to be displayed is determined based upon the size of the song title display area 7c.

FIG. 3(a) is an example where the user interface 7 is configured to fit the display screen of the PDA 10 entirely. In further embodiments of the present invention, the user interface 7 may be configured to use a window, such that the window only uses a portion of the display screen of the PDA 10. As such, the window can be dragged across the screen and a size of the window can be easily adjusted. When the size of the window is changed, a location and a size of each type of button and each display area can be adjusted to fit the new window size properly, then the number of song titles listed in the song title display area 7c is set again according to the changed size of the song title display area 7c.

When the remote control program is used, the remote control program transmits a genre request to the media player 20 requesting each type of genre stored on the media player 20. The media player 20 receives the genre request and transmits the types of genre back to the PDA 10. A leadoff genre is then displayed in the genre display area 7a. The remote control program then transmits a request to display song titles in the song title display area 7c to the media player 20. When the song titles are requested from the media player 20, the song titles are displayed in the song title display area 7c when the song titles are received. In various embodiments of the present invention, the remote control program transmits a song title request with the number of song titles displayed in the song title display area to the media player and may receive an appointed number of song titles from the media player. In further embodiments of the present invention, the remote control program transmits a song title request to the media player and may receive one song title from the media player, and the remote control program may repeat this process in a time corresponding to the number of song titles displayed in the song title display area 7c.

In various embodiments of the present invention, the genre-changing button 7b can be displayed as two buttons: a left-facing arrow and a right-facing arrow, for example. If either of these buttons is pressed, the genre displayed in the genre display area 7a is changed to a new genre. Pressing the right-facing arrow may change the genre in a certain order, while pressing the left-facing arrow may change the genre in reverse. When the genre-changing button 7b is used, the remote control program of the PDA 10 sends a song title request pertaining to the new genre to the media player 20. When the song titles are received, the song title display area 7c displays the song titles accordingly.

In various embodiments of the present invention, if the genre is changed, the leadoff song from the songs included in the changed genre may be selected. In further embodiments of the present invention, the song number of the last selected song in each genre is stored. If the genre is changed, the stored song number may be read in response to the changed genre. In response to that number, a song selection is made.

When the electronic computing device, such as the PDA 10, is activated by the remote control program, the remote control program requests the number of genres stored on the media player 20 and requests the name of the leadoff genre and the song titles included in the genre. If the genre is changed (i.e., the genre-changing button 7b is used), the remote control program requests information on the new genre and the associated songs with the new genre. When the information on the new genre is received, the new genre is displayed in the genre display area 7a. The remote control program then requests from the media player 20, the song titles associated with the new genre. When that information is received, the song titles are displayed in the song title display area 7c.

In various embodiments of the present invention, the song title-changing button 7k can be displayed as two buttons: an upward-facing arrow and a downward-facing arrow, for example. When the song title-changing button 7k is used, the remote control program transmits a new song title request to the media player 20. When the new song titles are received, the song titles are displayed in the song title display area 7c.

For example, as shown in FIG. 3(a), according to an embodiment of the present invention, when the genre “folk” is selected, five song titles (numbered 1-5), one of which is “Greensleeves”, are displayed in the song title display area 7c. When the downward-facing arrow of the song-title changing button 7k is pressed, a next set of five song titles (numbered 6-10) are requested from the media player 20. Once the request is received, the next set of song titles (numbered 6-10) are displayed in the song title display area 7c. Accordingly, every song categorized under the folk genre can be displayed five at a time until the list is repeated.

When the Play button 7d is used, the remote control program transmits a command to the media player 20 to play a selected song. When the media player 20 receives the command, the media player 20 plays the selected song if the selected song or another song is not already playing. If the media player 20 is already playing a song or no song is currently selected, the media player 20 will not process the command.

When the stop button 7e is used, the remote control program transmits a command to the media player 20 to stop playing. When the media player 20 receives the command, the media player 20 stops playing the current song. If the media player is already not playing a song or no song is currently selected, the media player will not process the stop command.

When the mute button 7f is used, the remote control program transmits either a command to set a volume level of the media player 20 to “0” or to return the volume level to an original volume. If the volume level is not zero when the mute button 7f is pressed, the volume level is set to “0”. If the volume level is already set to zero then the volume level is returned to the original value. In various embodiments of the present invention, the volume level can be set and controlled from the media player 20. In further embodiments of the present invention, the volume level can be set and controlled by the remote control program.

When there is network connection between the PDA 10 and computer networking device 50 of the media player 20 via the wireless LAN transmission, the network indicator 7g lights up. When there is no network connection, the network indicator 7g does not light up.

As shown in FIG. 3(b), when the control button 7h is used, the control menu 9 is displayed on the screen. The control menu 9 may include a volume slider 9a or a volume switch 9b for incrementing or decrementing the volume level of the media player 20. The control menu 9 may also include a tempo slider 9c or a tempo switch 9d for incrementing or decrementing a tempo of the media player 20. The control menu 9 may further include a display bar 9e and a displayed keyboard 9f for setting a transposition on the display bar 9e. In addition, the control menu may include a close icon 9g for closing the control menu 9.

The remote control program may be configured to send a volume command to the media player 20 if the volume is changed. In addition to the mute button 7f, the volume can be changed either by sliding a knob along the volume slider 9a, or by clicking the volume switch 9b. The volume switch 9b may be configured as two buttons, such as an upward-facing arrow for increasing the volume and a downward-facing arrow for decreasing the volume. Accordingly, if the volume level is changed, a new volume level is transmitted to the media player 20.

The remote control program may be configured to send a tempo command to the media player 20 if the tempo is changed. The tempo can be changed either by sliding a knob along the tempo slider 9c, or by clicking the tempo switch 9d. The tempo switch 9d may be configured as two buttons, such as an upward-facing arrow for increasing the tempo and a downward-facing arrow for decreasing the tempo. Accordingly, if the tempo is changed, a new tempo level is transmitted to the media player 20. In various embodiments of the present invention, the new tempo level can be displayed on a metronome, or the like, that may be located near the tempo slider 9c or the tempo switch 9d.

The remote control program may be configured to send a transposition command to the media player 20 if the transposition is changed. The transposition of a musical note can be adjusted by, for example, dragging a black circle along the display bar 9e or by clicking a key on the displayed keyboard 9f. When the transposition is set to “Middle C” on the displayed keyboard 9f, the transposition has a value of “0”. By selecting a different key, the transposition has a different corresponding value. Accordingly, if the transposition value is changed, a new transposition value is transmitted to the media player 20.

When the media player 20 receives the volume command, the tempo command, or the transposition command, the media player 20 changes its settings to correspond with those commands. When the close icon 9g is used, the control menu 9 is closed and the user interface 7 is displayed.

When the display button 7i is used, a display window (not shown) is opened on the screen. The display window may be used for displaying performance timbres, graphical content, or the like. When the display window is opened, the media player 20 receives a command to display the performance timbres, the graphical content, or the like when the media player 20 is able to do so. If the display button 7i is used while the display window is already open, the display window closes.

When the function button 7j is used, a function window (not shown) is opened on the screen. The function window may be used for displaying, for example, musical notes from the media player 20. If the function button 7j is used while the function window is already open, the function window closes.

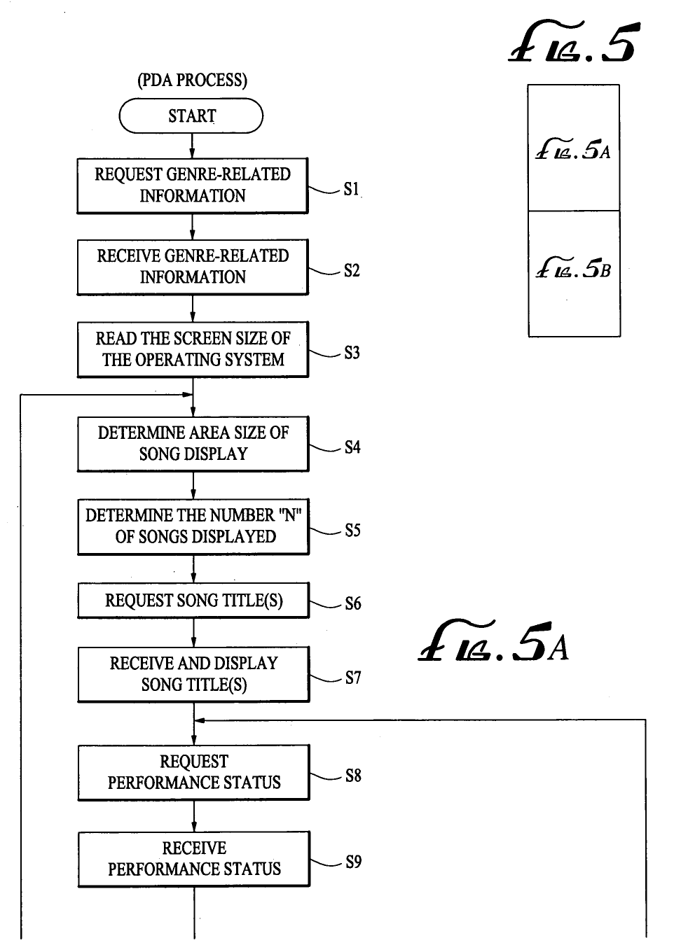

The display screen of FIG. 3(a) is one where the display screen is relatively small, such as the display screen of the PDA 10 or smart phone. FIG. 4 illustrates an example of a user interface 7 using a larger display screen, such as a display found on a notebook computer, in accordance with an embodiment of the present invention.

As shown in FIG. 4, the user interface 7 may be longer horizontally and/or vertically to take advantage of the larger display screen, to include ten song titles (numbered 1 to 10) in the song title display area 7c. The display areas and button types of the user interface 7 are the same as those shown in FIG. 3(a).

Regarding information transmitted by the PDA 10 to the media player 20, a genre number request is a request for the number of genres stored on the HDD 30 of the media player 20. A genre information request which includes a genre name or number associated with the genre is a request for information of the genre name and the number of songs included in that genre.

A song title request corresponds to the genre information received in response to the genre information request. The song title request is transmitted with the name of the requested genre and song numbers.

A song selection includes the song number selected by a user. The user makes a selection from the song titles displayed in the song display area 7c. When a selection is made, the song number associated with the selected song is transmitted to the media player 20.

In a status request, the PDA 10 requests a current status of the media player 20 (i.e., whether or not a song is currently playing). The remote control program sends a command, such as the play command, the stop command, the mute command, the volume adjustment, the tempo adjustment, and transposition, etc. when the user inputs the command.

Regarding information transmitted by the media player 20 to the PDA 10, the genre number information is the number of genres stored in the HDD 30 of the media player 20. The genre information includes the genre name and the number of songs in that genre. Song title information includes both the song title and the song number associated with a song title. Status information display information on whether a song is currently playing or not.

FIG. 5 is a flowchart of an example of the processes performed by the remote control program for playing and selecting a song on the media player 20. The remote control program of FIG. 5 corresponds to the user interface 7 shown in FIG. 3(a).

In S1, a request for genre-related information (e.g., the genre number request and the genre information request) for songs is transmitted via wireless LAN to the media player 20. In S2, genre-related information is received from the media player 20. The genre-related information includes the number of genres stored on the HDD 30 of the media player, the name of each genre and the song titles within the genre.

Next, in S3, the size of the user interface 7 and the resolution (i.e., dots per inch) of the display screen, which was installed by the OS on the PDA 10, are read. Accordingly, next, in S4, the user interface 7 can be configured to properly display the size and position of the buttons, genre display area 7a, and the song title display area 7c on the display screen. In S5, the number “N” of songs displayed in the song title display area 7c is set. For example, as shown in FIGS. 3(a) and 4 respectively the value of N is equal to five and ten, respectively, and therefore the song title display areas 7c of each is configured to display five and ten song titles, respectively.

Next in S6, the remote control program transmits an information request for the song titles of a first set of songs in the current genre to the media player 20. In S7, the request is fulfilled by the media player 20 by sending the song titles of the first set of songs of the current genre and then displaying them in the song title display area 7c.

In S8, the remote control program requests a status of the media player 20. In S9, the remote control program receives the status information of the media player 20. Accordingly, when a song is in progress, the media player 20 sends status information to the PDA 10 indicating as such. Likewise, when the performance stops, the media player 20 transmits status information indicating the performance has stopped. For example, if the media player 20 is playing a song, the user interface 7 can display animation indicating that a song is in progress, while the speakers of the media player 20 output sound. Likewise, if the media player 20 is not playing a song, the user interface 7 can display animation indicating that no song is in progress.

Next in S10, the remote control program determines whether the genre-changing button 7b is used. In S11, if the genre-changing button 7b is used (S10: Yes), then the name of the genre type is changed in the genre display area 7a to the next possible genre type and a first set of song titles of the new genre are requested from the media player 20 as done in S6. The first set of song titles are sent in accordance with the request, and the song title display area 7c displays the first set of song titles of the new genre as done in S7.

Next in S12, the remote control program determines whether the song title-changing button 7k is used. In S13, if the song-title changing button 7k is used (S12: Yes), then a next set of song titles following the set of song titles currently displayed are requested from the media player 20. The song titles are received in response to this request and the song title display area 7c is refreshed reflecting the next set of song titles. For example, as shown in FIG. 3(a), the first set of song titles displayed in the song title display area 7c are numbered 1 through 5. After pressing the song-title changing button 7k, the song title display area 7k would display the next set of song titles, which would be numbered 6 through 10.

In S14, the remote control program determines whether the window size and position has been changed. If the window size is changed (S14: Yes), the remote control program returns to S4 to set the number “N” of songs in the song display area 7c.

In S15, the remote control program determines whether a song has been selected from among the displayed song titles. In S16, when a song is selected (S15: Yes), the song selection information (i.e., the song number associated with the selected song) is transmitted to the media player 20.

When the media player 20 receives the song number and the media player 20 is not already playing a song, the media content corresponding to the song number is read from the HDD 30. The media player 20 then plays the selected song. In various embodiments of the present invention, if the media player 20 receives the song number while the media player 20 is already playing a current song, playing of a current song is stopped forcibly, then the media content corresponding to the song number is read from the HDD 30. In further embodiments of the present invention, if the media player 20 receives the song number while the media player 20 is already playing a current song, the song number is queued in the RAM 26. When the media player 20 completes playing the current song, the media content corresponding to the song number is read from the HDD 30, thus allowing the queuing of a number of songs to play in the order received when the previous song is done playing.

In S17, the remote control program determines whether other commands, such as the play command, the stop command 7e, etc. have been inputted. In S18, the commands that have been inputted (S17: Yes) are performed accordingly. When there are no other operations to perform, the remote control program returns to S8 to request the status of the media player 20.

FIG. 6 is a flowchart of an example of processes performed by the media player 20 in response to the remote control program. The processes activate a battery (not shown) installed within the media player 20. The media player 20 will continue to execute the processes until the on/off power switch is placed into the off position.

In S21, the media player 20 determines whether a genre-related information request (e.g., the genre number request or the genre information request) has been received from the remote control program (refer to S1). In S22, once determining the genre-related information request was received (S21: Yes), the media player 20 transmits the genre-related information, which includes the number of genres, the name of each genre and the song titles included in that genre, to the PDA 10 (refer to S2).

Next in S23, the media player 20 determines whether it has received a status request from the PDA 10 (refer to S8). In S24, if the media player 20 is currently playing a song when the request is received, the media player 20 sends status information indicating as such to the PDA 10 (refer to S9). Likewise, if the media player 20 is not currently playing a song when the request is received, the media player 20 sends status information indicating as such to the PDA 10.

In S25, the media player 20 determines whether a song title request (refer to S6) by the PDA 10 has been received. When the song title request information has been received (S25: Yes), the media player 20 fulfills the request by transmitting a first set of song titles and associated song numbers to the PDA 10. In accordance with this request, the remote control program displays the first set of song titles and the associated song numbers on the PDA 10 (refer to S7).

In S27, the media player 20 determines whether a selected song number has been received (refer to S15, S16). In S28, when the selected song number is received, the media content associated with the selected song number is read from the HDD 30 of the media player 20. The media player 20 then plays the song. If the media player 20 is currently playing a current song when the selected song number is received, after the current song is finished playing, the HDD 30 reads the media content associated with the selected song number. The media player 20 then plays the song.

In S29, determines whether other commands, such as the play command, have been received from the PDA 10 (refer to S17). In S30, when the other commands are received from the PDA 10 (S29: Yes), the commands are processed accordingly.

In S31, the media player 20 determines whether further commands, such as a change in volume level, a change in tempo level, etc., have been ordered. When the volume level and the tempo level, for example, are transmitted to the PDA 10, the information is accurately displayed on the PDA 10. When S31 is complete, the media player 20 returns to S21.

In various embodiments of the present invention, the media player 20 is configured to communicate with the PDA 10 via a wireless LAN. With the remote control program installed on the PDA 10, the PDA 10 is configured to select and control songs located on the media player 20.

In various embodiments of the present invention, the user interface 7 of the PDA 10 requests the size of the song selection screen to display the requested song titles in the song title display area 7c.

In various embodiments of the present invention, depending on the size of the song selection window of the user interface 7, the user interface 7 can be configured to display a set number of song titles. In further embodiments of the present invention, the set number of song titles can be adjusted in response to the size of the song selection window and font size of the song titles. For example, when a small font size is used, a larger number of songs can be displayed on the PDA 10. Meanwhile, when a large font size is used, a smaller number of songs can be displayed on the PDA 10. Font size can be configured by the hardware, such as that found in the PDA 10, selected by the user, or changed in response to the screen resolution or the size of the display screen expressed by the length of a diagonal of the display screen.

In various embodiments of the present invention, automatic performance data is stored in the song data memory 30a. When a song is played, the song performance data is sent to the sound generator 34 of the media player 20, which generates music. In further embodiments of the present invention, the song data stores PCM (pulse code modulated) waveforms, which can be read sequentially and be replayed at a set frequency sampling. In further embodiments of the present invention, the media player 20 is configured for use with a controlled sequencer communication of a sound generator, such as the sound generator 34, and MIDIs.

In various embodiments of the present invention, the electronic computing device is the PDA 10. In further embodiments of the present invention, the electronic computing devices can be personal computers, mobile phones, other PDAs, and other devices that communicate wirelessly with other electronic equipment.

In various embodiments of the present invention, the media player 20 and the PDA 10 are configured to communicate wirelessly. In further embodiments of the present invention, the media player 20 and the PDA 10 may be configured to communicate via a wired connection, such as, but not limited to, RS-422, USB, IEEE1394, MIDI, or the like.

In various embodiments of the present invention, the media player 20 and the PDA 10 are configured to communicate via a wireless LAN connection. In yet further embodiments of the present invention, the media player 20 and the PDA 10 may be configured to communicate via Bluetooth, and IrDA (infrared data association).

In various embodiments of the present invention, the computer networking device 50, such as a router, is a separate unit from the media player 20. However, in various embodiments of the present invention, the transmitter switch equipment may be embedded in the media player 20. Accordingly, the media player 20 and the PDA 10 are configured to communicate wirelessly.

In various embodiments of the present invention, the remote control program may be designed with Macromedia Flash software. However, in other embodiments of the present invention, the remote control program may be designed with other applications such as JAVA script.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

What is claimed is:

1. A media system for playing content on a media player with an electronic computing device, the media system comprising:
a storage medium for storing and reading song data;
a first transmission interface for relaying song data to the electronic computing device, receiving a song title request from the computing device, transmitting the song titles to the computing device, and receiving a song selection request from the computing device;
a second transmission interface for transmitting the song title request to the media player, receiving song titles from the media player, and transmitting the song selection request to the media player; and
a display screen for displaying the song titles received from the media player and for selecting a song from the song titles;
wherein the media player is configured to process song data corresponding to the song selection request.

2. The media system of claim 1,
wherein at least some of the song titles are transmitted by the first transmission interface in response to the second transmission interface transmitting the song title request;
wherein said at least some of the song titles are received by the second transmission interface; and
wherein said at least some of the song titles are displayed on the display screen.

3. The media system of claim 1,
wherein the electronic computing device is configured to set the number of song titles displayed on an area of the display screen according to a size of said area of the display screen; and
wherein said number of song titles are displayed in said area of the display screen.

4. The media system of claim 3,
wherein said number of song titles are transmitted by the first transmission interface in response to the second transmission interface transmitting the song title request; and
wherein said number of song titles are received by the second transmission interface.

5. The media system of claim 1, the system further comprising:
a networking device connected to the media player, the networking device configured for wireless communication;
a wired connection configured for use with the media player, the wired connection for receiving and transmitting information from the electronic computing device via the networking device; and
a wireless connection configured for use with the electronic computing device, the wireless connection for receiving and transmitting information from the media player via the networking device;
wherein the first transmission interface communicates with the networking device via the wired connection; and
wherein the second transmission interface communicates with the networking device via the wireless connection.

6. The media system of claim 5,
wherein the first transmission interface communicates with the wired connection with an RS-232C connection; and
wherein the second transmission interface communicates with the wireless connection using a TCP/IP protocol via a wireless LAN connection.

7. The media system of claim 1,
wherein the electronic computing device is a personal digital assistant (PDA).

8. The media system of claim 1,
wherein the electronic computing device is a personal computer.

9. A method for remotely selecting a song via an electronic computing device, the method comprising steps of:
transmitting a song title request to a media player via a transmission interface, the media player configured for storing and reading song data;
receiving song titles from the media player via the transmission interface;
displaying at least some of the song titles on a display screen;
selecting a song title from among said at least some of the song titles displayed on the display screen;
transmitting a song selection request to the media player via the transmission interface, the song selection request corresponding to the selected song title.

10. The method of claim 9,
wherein the display screen displays a number of song titles when the song titles are received from the media player.

11. The method of claim 9,
wherein the electronic computing device is configured to set the number of song titles displayed on an area of the display screen according to a size of said area of the display screen; and
wherein said number of song titles are displayed in said area of the display screen.

12. The method of claim 11,
wherein said number of song titles are transmitted in response to the transmission interface transmitting the song title request; and
wherein said number of song titles are received by the transmission interface.

13. The method of claim 11,
wherein the electronic computing device is configured to run an operating system, wherein the electronic computing device is configured to set the number of song titles displayed on an area of the display screen according to stored display screen size information.

14. The method of claim 9,
wherein the song data stored by the media player includes a plurality of songs organized by genre type;
wherein the electronic computing device is configured to receive the genre type and the song titles corresponding to said genre type in response to transmitting the song title request.

15. The method of claim 9,
wherein the electronic computing device includes a browser, the browser configured to display said some of the song titles on the display screen.

16. A method for playing content on a media player via a remote control program of an electronic computing device, the method comprising steps of:
receiving a song title request via a transmission interface;
transmitting song titles stored within the media player to the electronic computing device via the transmission interface;
receiving a song selection request via the transmission interface;
reading song data stored on the media player, the song data corresponding to the song selection request; and
processing the song data.
